(19) United States
(12) Patent Application Publication
(10) Pub. No.: US 2007/0003807 A1
(43) Pub. Date: Jan. 4, 2007

(54) Fullerene containing composite membranes

(76) Inventors: Fred Wudl, Santa Barbara, CA (US); Galen D. Stucky, Santa Barbara, CA (US); Hengbin Wang, Camarillo, CA (US); Bruno Jousselme, Antibes (FR); Ken Tasaki, Goleta, CA (US); Arunkumar Venkatesan, Twinsburg, OH (US); Ryan Desousa, Fort Worth, TX (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/435,556

(22) Filed: May 16, 2006

Related U.S. Application Data
(63) Continuation-in-part of application No. 11/067,599, filed on Feb. 25, 2005.
(60) Provisional application No. 60/681,822, filed on May 16, 2005.

(51) Int. Cl. H01M 8/10; B29C 39/00

(52) U.S. Cl. 429/33; 264/299

(57) ABSTRACT

A membrane/film casting method for fabricating composite membranes/films, and the produced composite membranes/films thereby fabricated, from a host polymer and a fullerene, often with the mixing of the host polymer and fullerene further promoted by a poly(ethylene oxide) attached fullerene mixing agent.

### CROSS-REFERENCE TO RELATED APPLICATIONS

This application is a Continuation-In-Part of co-pending application Ser. No. 11/067,599, filed on Feb. 25, 2005, incorporated herein by reference in its entirety. This application claims priority from U.S. provisional application Ser. No. 60/681,822, filed on May 16, 2005, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to novel composite membranes/films and proton conducting membranes (PCMs) and the components utilized to produce these composite membranes/films and PCMs. More particularly, the subject invention relates to novel composite membranes/films, PCMs, fabrication methods, and membrane/film constituent components comprising a host polymer, fullerenes, hydrogen fullerenes, polyhydroxy fullerenes, hydrogen cyano fullerenes (C₆₀H(CN)ₓ) as proton-source agents, and often poly(ethylene oxide) attached fullerenes (C₆₀(PEO)_{y} or PEOC₆₀) as mixing agents to facilitate PCM formation with the host polymer.

2. Description of Related Art

The subject invention is often, though not exclusively, utilized as a major component of a polymer electrolyte fuel cell (PEFC). PEFCs are generally comprised of three major components: the anode; the proton conducting membrane (PCM, one area involving the subject invention); and the cathode. The PCM plays a critical role of transporting a proton from the anode to the cathode. It has to be highly proton conductive and also mechanically, thermally, and chemically stable. Water is produced at the interface between the cathode and the membrane. This water can be problematic, as discussed below, in operation of a PEFC. Lack of suitable membrane availability has been hindering the commercialization of PEFC. Water management is one of the most difficult issues in operating a PEFC. The water in the PEFC is produced as a product at the cathode side in PEFC. A breakdown in water balance between production and loss of water at the cathode side often results in water flood, while the anode interface with the membrane may suffer from water depletion due to water transportation toward the cathode side. Both the flood and the depletion may increase the cell over-potential which results in loss of power. Furthermore, the most commonly used PCMs are based on sulfonated perfluoro polymers that need to be fully humidified to be functional during the operation of the PEFC. Thus, these sulfonated perfluoro polymers not only require a humidifier, but also need an even distribution of water across the membrane which becomes an additional concern because of the membrane's high dependence on water.

Dry operation of PEFC may alleviate some of the water management problems. In fact, there is a strong demand in the auto industry as well as the distributed power generation industry for PEFC functional under low relative humidity (RH) (<50% RH). [Mathias, M.; Gasteiger, H.; Makharia, R.; Kocha, S.; Fuller, T.; Xie, T.; Pisco, J. Preprints of Symposia-American Chemical Society, Division of Fuel Chemistry 2004, 49(2), 471474] Currently, no commercially available PCM meets this demand. NAFION, the industrial standard PCM by DuPont, is widely used in PEFC; yet it is sensitive to humidity, a very undesirable characteristic. Other existing proton conducting membranes, commercially available or under development, are as good or even better than NAFION under fully humidified condition, but very few outperform NAFION under low humidity conditions.

One existing PCM is disulfonated poly(arylene ether sulfone) copolymer (BPSH) developed by McGrath and coworkers. [Wang, F.; Hickner, M.; Kim, Y. S.; Zawodzinski, T. A.; McGrath, J. E. J. Membr. Sci. 2002, 197, 231] Though BPSH is thermally stable and mechanically durable, and widely used as one of the most advanced alternative PCM, its proton conductivity under low RH (<80%) is lower than that of NAFION. Lack of membranes capable of functioning under low RH, (i.e., maintaining high conductivity, ˜10⁻¹ S cm⁻¹) has been an obstacle to bringing PEFC to market. The challenge for the industry is how to improve the conductivity of PCMs, where water plays a vital role in proton transportation, under dry condition.

A typical approach previously attempted to improve the conductivity of PCMs under low RH has been to increase the degree of sulfonation in the PCM in an attempt to increase the overall conductivity. [Tchatchoua, C.; Harrison, W.; Einsla, B.; Sankir, M.; Kim, Y. S.; Pivovar, B.; McGrath, J. E., Preprints of Symposia-Am. Chem. Soc., Div. of Fuel Chem. 2004, 49(2), 601] The problem with such an approach is that the membrane tends to swell more with a higher degree of sulfonation, which is detrimental in operation of fuel cell since the dimensional stability of the PCM is a key to the operation. Also, there is synthetic difficulty associated with increasing degree of sulfonation. Furthermore, there is a theoretical limit to the conductivity due to the sulfonyl groups (—SO₃H) in the membrane.

An existing alternative approach to improve proton conductivity is a fabrication of composite membranes based on the conventional water-based PEM and inorganic/organic additives including SiO₂ and heteropolyacids (HPA). [Shao, Z-G.; Joghee, P.; Hsing, I-M. J. Membr. Sci. 2004, 229, 43] Especially, HPA has been widely used to improve the performance of proton conducting membranes. [Herring, A. M.; Turner, J. A.; Dec, S. F.; Sweikart, M. A.; Malers, J. L.; Meng, F.; Pern, J.; Horan, J.; Vernon, D. Abst. 228th Am. Chem. Soc. National Meeting, Philadelphia, Pa., Aug. 22-26, 2004 FUEL-053] The problems with HPA, however, are that it is water-soluble, thus leaches out, and the proton conductivity is sensitive to humidity. [Katsoulis, D. E. Chem. Rev. 1998, 98, 359] Hence, immobilization of HPA in a membrane is a particularly important issue. [Kim, Y. S.; Wang, F.; Hickner, M.; Zawodzinski, T. A.; McGrath, J. E. J. Membr. Sci. 2003, 212, 263]

An existing and more radical approach to improve proton conductivity is to replace water altogether. PCM with low volatile solvents such as imidazole have been utilized to replace water. [Kreuer, K. D.; Fuchs, A.; Ise, M.; Spaeth, Maier, M. J. Electrochim. Acta 1998, 43, 1281] Though the proton conductivity of 10⁻² S cm⁻¹ has been achieved at high temperatures, imidazole is known to poison the Pt catalyst and also is subject to diffusing out of the membrane, which is currently fixed through chemical attachment to a host polymer. [Schuster, M. F. H.; Meyer, W. H.; Schuster, M.; Kreuer, K. D. Chem. Mater. 2004, 16, 329] Also, work exists in which a polybenzimidazole membrane was doped by H₃PO₄ (PBI/H₃PO₄). [Fontanella, J. J.; Wintersgill, M. C.; Wainright, J. S.; Savinell, R. F.; Litt, M. Electrochimica Acta 1998, 43, 1289] Yet, H₃PO₄ is known to be leached out by water on the cathode side. Improvement of the performance of a PBI/H₃PO₄ membrane has been achieved through the use of polyphosphoric acid, however, the poor performance at low temperature and leaching out of H₃PO₄ by water condensation remain unsolved. [Zhang, H.; Chen, R.; Ramanathan, L. S.; Scanlon, E.; Xiao, L.; Choe, E-W.; Benicewicz, B. C. Prep. Div. Fuel Cehm. Am. Chem. Soc., Philadelphia, Pa., Aug. 22-26, 2004, 49, 588] In another approach to replace water, inorganic solid acids such as CsHSO₄ have been used. [Haile, S. M.; Boysen, D. A.; Chisholm, C. R. I.; Merle, R. B. Nature (London, United Kingdom) 2001, 410, 910] However, there are concerns regarding this solid acid: reduction of the sulfur in the CsHSO₄ electrolyte may occur over time, the reaction with hydrogen forms hydrogen sulfide, and also a poisoning to the Pt catalyst may occur. Other solid acids may be less problematic, but the stability of the materials remains problematic since the operation temperatures for these solid acids are close to their thermal decomposition temperatures. Thus, anhydrous (non-water) membranes have not reached a practical stage for operation of PEFC.

Although limited details are provided, a journal article by Saab et al. provides the first limited experimental data on the ionic conductivity of chemically functionalized fullerene. [Saab, A. P.; Stucky, G. D.; Passerini, S.; Smyrl, W. H., Fullerene Science and Technology, 1998, 6, 227.]

U.S. Pat. No. 6,495,290 B1 discloses proton conducting materials composed of carbon materials including fullerenes with functional groups attached to them. [Hinokuma, K., Ata, M., J. Electrochem. Soc. 150 (2003) A112] It is claimed that the '290 materials can be used for PCM under dry condition. The best conductivity achieved using their materials under dry condition was 10⁻⁴ S cm⁻¹, not very high for operation of a PEFC. The difference from the current subject invention is that: (i) the subject invention's performance is much higher, ˜10² S cm⁻¹, than theirs, though the subject invention PCM also uses different fullerene-based materials; (ii) their materials lose performance as the content of their fullerenes in the PCM decreases below 80 wt %, while the subject invention PCM exhibits high performances with only 20 wt % of the subject novel fullerenes in a host polymer; and (iii) the subject invention functional groups attached to the fullerenes are completely different from those listed, suggested, or taught in '290. Furthermore, the '290 approach is to use fullerene as a carrier of proton hopping sites such as the OH groups for proton transportation where a proton is transported between the functional groups attached to fullerene. On the contrary, the subject invention uses novel fullerene derivatives as strong proton sources, i.e., the function in the subject invention is different from '290. Thus, a difference is that the '290 invention relies on the functional groups on fullerenes for proton transportation, while the subject invention uses water as the proton transportation medium and the derivatized fullerenes promote proton conduction as a proton-source, especially under low humidity. Additionally, when cyano groups (—CNs) are mentioned in '290 the cyano groups are considered to be only “electron attractive groups” that may be “introduced together with” the other listed critical functional groups and only serve to assist the non-cyano functional groups that must also be present.

Recently, the Sony Corporation has developed proton conducting materials based on functionalized fullerenes, U.S. Pat. No. 6,495,290 and U.S. Pat. No. 6,726,963. [K. Hinokuma, M. Ata, Proton Conduction in Polyhydroxy Hydrogensulfated Fullerenes, J. Electrochem. Soc. 150 (2003) A112] Through optimization of functionalization to C₆₀, mostly with the OSO₃H and the OH groups, they have achieved the best performance of the fullerene-based membrane with 10⁻² S cm⁻¹ of proton conductivity under dry condition. Nevertheless, the membrane was a pellet of fullerene derivatives pressed under high pressure. A pellet has little practical use as a proton conducting membrane for fuel cell applications where a flexibility, a ductility, a durability, and stable mechanical properties are required as the prerequisite for proton conducting membranes. Similarly, the Honjo Chemical Corporation pressed fullerene derivatives into a pellet by pressure to fabricate a proton conducting material for dry operation of fuel cell. [Yoshida, G. Tokukai 2004-247057] On the other hand, a proton conducting material was made by mixing fullerene with porous materials, Tokukai 2004-265698. [Kumazawa, K., Tokukai 2004-265698] Yet, its mechanical properties are not clear. Alternatively, Cape Cod Research, Inc. has prepared a proton exchange membrane by mixing fullerene derivatives in a dry gel material through casting suspensions containing the fullerene and the precursors of the dry gel material using a sol-gel method for dry operation of fuel cells. [Bhamidipati, M. V., US Patent Application No. 2004/0224203A1] This technique is only limited to a sol-gel method.

One aspect of the subject invention is to make useful, mechanically stable and flexible composite membranes through a casting of a solution mixed with fullerene and a polymer, which can be applied to a wide range of polymers, including cyano hydrogen fullerene, C₆₀H(CN₃) mixed in poly(ethylene oxide). No known report has ever been made concerning the fabrication of fullerene-NAFION composite membranes. Polyhydroxyhydrogen sulfated fullerene, C₆₀(OSO₃H)ₘ(OH)ₙ, was mixed in a NAFION 117 membrane by doping, but not by the method of the subject invention (solution casting). [Loutfy, et al. PCT WO 2004-US18868] In doping, a membrane was swollen in alcohol, and the fullerene derivative was incorporated into the pores of the membrane. The same fullerene was also mixed with poly(ethylene oxide) in solution and cast to a membrane. [Loutfy, et al. PCT WO 2004-US18868] Also, fullerene derivatives have been incorporated to polymers such as NAFION [Guo, et al. Langmuir, 2002, 18, 9017; Zhang, et al. Chem. Mater. 2003, 15, 4739; and Sun, et al. Synthetic Metals, 2003, 135, 849] and polystyrene [Polotskaya, et al. J. App. Polym. Sci. 2002, 85, 2946] in the past and the fullerene derivatives were all incorporated in NAFION through doping. Furthermore, none of these techniques has been applied to fuel cell proton conducting membranes.

### BRIEF SUMMARY OF THE INVENTION

An object of the present invention is to describe a method for producing stable composite membranes/films and the membranes/films made therefrom.

Another object of the present invention is to present a solution casting method for producing fullerene containing composite membranes/films and the membranes/films made therefrom.

An additional object of the present invention is to relate a solution casting method for producing fullerene containing composite membranes/films and the membranes/films made therefrom, wherein a host polymer and fullerene are combined.

A still further object of the present invention is to disclose a solution casting method for producing stable fullerene containing composite membranes/films and the membranes/films made therefrom, wherein a host polymer and hydrogen and/or cyano derivatized fullerene are combined with a poly(ethylene oxide) derivatized fullerene mixing agent.

Generally, the present invention is embodied in a casting method of fabricating a fullerene composite membrane. The subject method comprises the steps: a selected fullerene is dissolved in a first solvent producing a first solution; a selected polymer is dissolved in a second solvent producing a second solution; the first and second solutions are mixed together producing a third solution; and the third solution is cast to generate the desired composite membrane/film.

Additionally, in general, the subject invention further comprises a PCM having a host polymer and a proton-source agent. The proton-source agent comprises a carbon cluster derivative, wherein the carbon cluster is derivatized with both hydrogen and cyano moieties. The carbon cluster derivative comprises from about 0.01 wt % to about 80 wt % of the PCM and may be physically blended with the host polymer or attached to the host polymer. Although any suitable carbon cluster (such as a fullerene family member or equivalent molecule such as a carbon nano-tube, open or closed carbon cage-molecule, and the like) that does not interfere with the structural and functional characteristics of the PCM is contemplated to be within the realm of this disclosure. The preferred carbon cluster is usually one of the family of carbon structures known as fullerenes and therefore the carbon cluster derivative usually comprises a hydrogen cyano fullerene.

A host polymer is any polymer utilized to generate a functioning PCM such as poly(ethylene oxide) and the like.

When a carbon cluster derivative is blended with a host polymer, the composition may further comprise a mixing agent to promote blending of the carbon cluster derivative with the host polymer. The subject mixing agent comprises one or more poly(ethylene oxide) side chains attached to a carbon cluster, wherein the carbon cluster preferably comprises a fullerene family member or equivalent molecule such as a carbon nano-tube, open or closed carbon cage-molecule, and the like.

It is noted, in general, that the subject PCMs, comprised of the novel subject components, possess an improved performance over existing PCMs under low humidity, <50% relative humidity (RH), and at high temperature (>120° C.) in the operation of polymer electrolyte fuel cells (PEFC).

Further objects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 shows chemical representations for two specific forms of hydrogen cyano fullerenes, C₆₀H(CN) and C₆₀H(CN)₃, the general acid source in the subject invention, wherein a general formula is C₆₀H(CN)ₙ with “n” running from 1 to about 60.

FIG. 2 shows chemical representations for two specific forms of poly(ethylene oxide), Mono PEOC₆₀ and Di PEOC₆₀, general mixing agents in the subject invention, wherein a general formula is C₆₀{N(CH₂CH₂O)ₙCH₃}ₘ with “n” running from 1 to about 45 or greater and “m” running from 1 to 2 or greater.

FIG. 3 shows a chemical representation for a general mixing agent in the subject invention, wherein the general formula is C₆₀{CH₂C₆H₄O(CH₂CH₂O)ₙCH₃}ₘ with “n” running from 1 to about 45 or greater and “m” running from 1 to about 8 or greater.

FIG. 4 shows a synthesis scheme for the compounds C₆₀H(CN), C₆₀H(CN)₃, C₆₀(CN)₂, and C₆₀(CN)₄.

FIG. 5 shows a synthesis scheme for exemplary C₆₀{CH₂C₆H₄O(CH₂CH₂O)ₙCH₃}ₘ (multi-PEO fullerene [PEOₘC₆₀] derivatives with various length sizes and numbers of PEOₘ chains) molecules by atom transfer radical addition (ATRA) reactions.

FIG. 6 shows the azide addition of PEO-azide to fullerene synthesis scheme utilized to produce exemplary C₆₀{(NCH₂CH₂O)ₙCH₃}ₘ molecules, made with numbers of and various lengths of PEO chains.

FIG. 7 shows the proton NMR spectra for C₆₀H(CN) and C₆₀H(CN)₃.

FIGS. 8A, 8B, and 8C show the IR spectra for C₆₀, C₆₀H(CN), and C₆₀H(CN)₃, respectively.

FIG. 9 shows a proposed reaction mechanism for the synthesis of poly(ethylene oxide) attached fullerenes.

FIG. 10 shows the proton NMR spectrum for multi-PEO fullerenes.

FIGS. 11A and 11B show EPR spectra for organic (11A) and transition metal (11B) radical signals from samples of (PEO₃)ₘC₆₀.

FIGS. 12A and 12B show MALDI-TOF spectra of (PEO₃)ₘC₆₀, (12A) and (PEO₈)ₘC₆₀ (12B).

FIG. 13 shows the UV-VIS spectra of Di (PEO₁₆)C₆₀ in various solvents and thin film.

FIG. 14 shows the conductivities of various membrane/film samples as a function of relative humidity.

FIG. 15A shows optical micrograms for membranes/films of DOPED 1 wt % C₆₀(OH)ₙ/NAFION 117 (left) and CAST 1 wt % C₆₀(OH)ₙ-NAFION (right).

FIG. 15B shows optical micrograms for CAST composite membranes/films of 1 wt % C₆₀H(CN)₃-NAFION (left) and 1 wt % C₆₀H(CN)₃-0.5 wt % PEOC₆₀-NAFION (right).

FIG. 16 shows proton conductivities for fullerene-NAFION composite membranes and NAFION 117 at 30° C.

FIG. 17 shows optical micrograms for membranes/films of lwt % C₆₀-NAFION (left) and lwt % C₆₀-0.5 wt %-PEOC₆₀-NAFION (right).

### DETAILED DESCRIPTION OF THE INVENTION

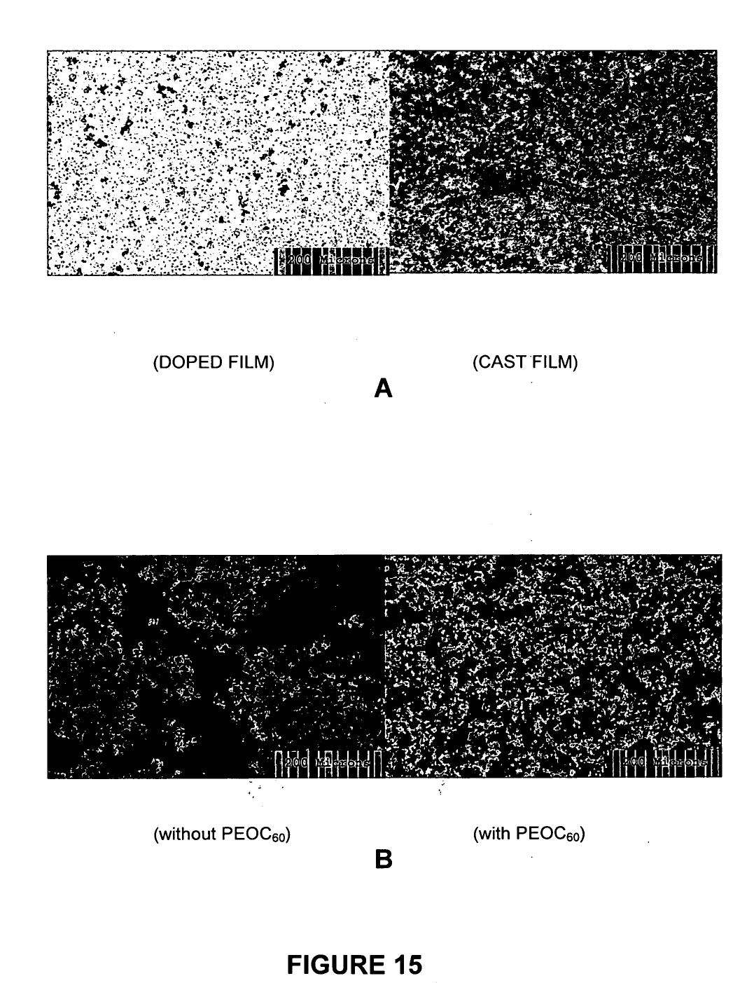

In a first embodiment of the subject invention and referring more specifically to the appropriate drawings (FIGS. 15, 16, and 17) for illustrative purposes, the present invention is embodied in a membrane/film casting method of fabricating a fullerene containing composite membrane/film, a proton conducting membrane/film is one particular form of such a composite membrane/film. The subject method comprises the steps: a selected fullerene is dissolved in a first solvent producing a first solution; a selected polymer is dissolved in a second solvent producing a second solution; the first and second solutions are mixed together producing a third solution; and the third solution is cast to generate the desired composite membrane/film. The solvents are selected from, but not limited to: dimethyl acetamide; dimethyl formamide; benzene (aromatic carbon solvent); and various chlorinated benzenes, including dichlorobenzene, ortho-dichlorobenzene and chlorobenzene (chlorinated aromatic carbon solvents).

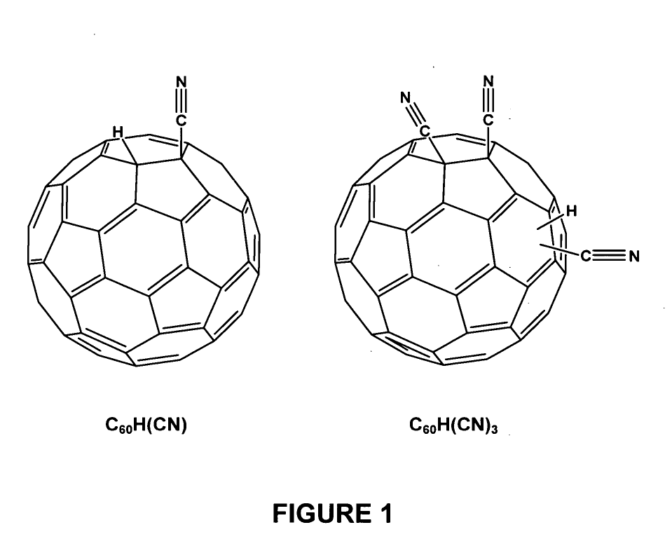

In a second embodiment of the subject invention and referring more specifically to the appropriate drawings (FIGS. 1-14) for illustrative purposes, the present invention is embodied in novel proton conducting membranes (PCMs) produced from various suitable combinations of the chemical structures generally shown in or related to those depicted in FIG. 1 through FIG. 3. It will be appreciated that the PCMs may vary as to their exact component percentages, without departing from the basic concepts as disclosed herein.

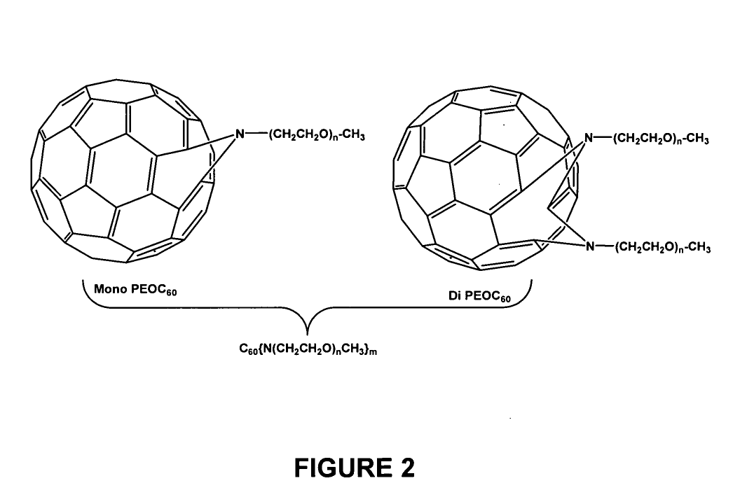

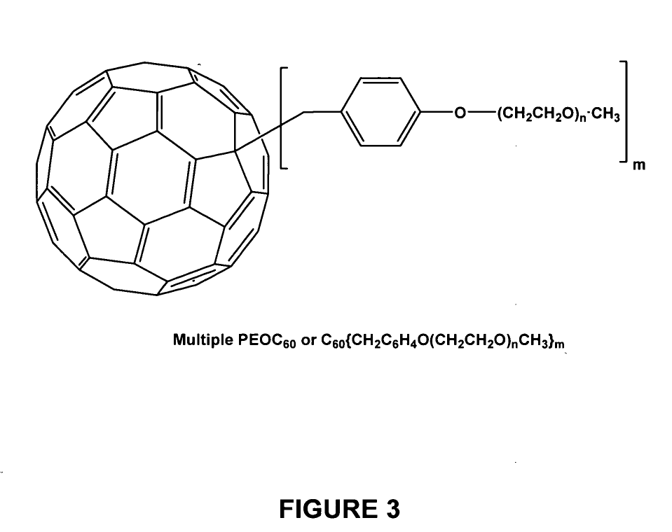

Generally, the subject invention comprises PCMs having novel proton-source agents and may also contain novel mixing agents that aid in blending the proton-source agents with the host polymer. Contrary to existing PCMs that derive their acidity from weaker acid species like the SO₃H group, a typical acid group found on traditional PCMs (pKa of C₆H₅SO₃H is approximately 2, while the pKa of C₆₀H(CN)₃ is approximately 0.7), the subject proton-source agents utilize stronger hydrogen and cyano acid moieties, yet the subject invention still uses water as a proton transportation medium. To facilitate proton conduction in the PCM, novel proton-source agents are employed that comprise hydrogen cyano derivatized carbon clusters that structurally and functionally incorporate into PCMs. Various types of carbon clusters are possible (see U.S. Pat. No. 6,495,290 B1, which is herein incorporated by reference, for a description of some carbon clusters commonly used or that may be used in forming PCMs), however, a preferred embodiment of the subject invention comprises carbon clusters that are specifically hydrogen cyano fullerenes (HCF; see FIG. 1) which are very strong acids. An HCF functions as an acid source in a PCM in which HCF is mixed in a host polymer or host polymer and a mixing agent (see FIGS. 2 and 3). Strong acids result in higher concentrations of protons, the ion carrier in PCM, in general, due to the higher proton dissociation of the acid; thus, the subject HCFs increase overall conductivity of a PCM, lifting conductivity versus relative humidity (RH). Stronger acids can also hold more so-called “bound water” which may be used for proton transportation, especially beneficial under low RH. The importance of bound water in a PCM has been recognized. [Kim, Y. S.; Dong, L.; Hickner, M. A.; Glass, T. E.; Webb, V.; McGrath, J. E. Macromolecules 2003, 36, 6281] This may decrease the slope of found in traditional conductivity vs. RH curves, which lifts the conductivity under low RH relative to that under higher RH.

It is noted that the hydrogen and cyano functional groups may be directly connected to the carbons within the carbon cluster/fullerene or physically displaced from the carbon cluster/fullerene surface by a spacer moiety such as methylene(s) or similar appropriate spacer unit(s).

One should appreciate that the proton-source agent may be directly or indirectly chemically coupled to the host polymer and not merely physically blended with the host polymer. Standard chemical coupling procedures may be utilized to generate such linkages.

Often included in the subject PCMs are mixing agents that promote the blending of the subject HCF in with a host polymer, thus allowing the subject HCFs to be well-dispersed throughout the membrane to achieve the maximum performance as a PCM.

More specifically, one embodiment of the subject invention comprises a hydrogen cyano fullerene acid source/proton-source agent, a host polymer, and, if desired, a poly(ethylene oxide) fullerene mixing agent.

Acid Source/Proton-Source Agent-Hydrogen Cyano Fullerenes

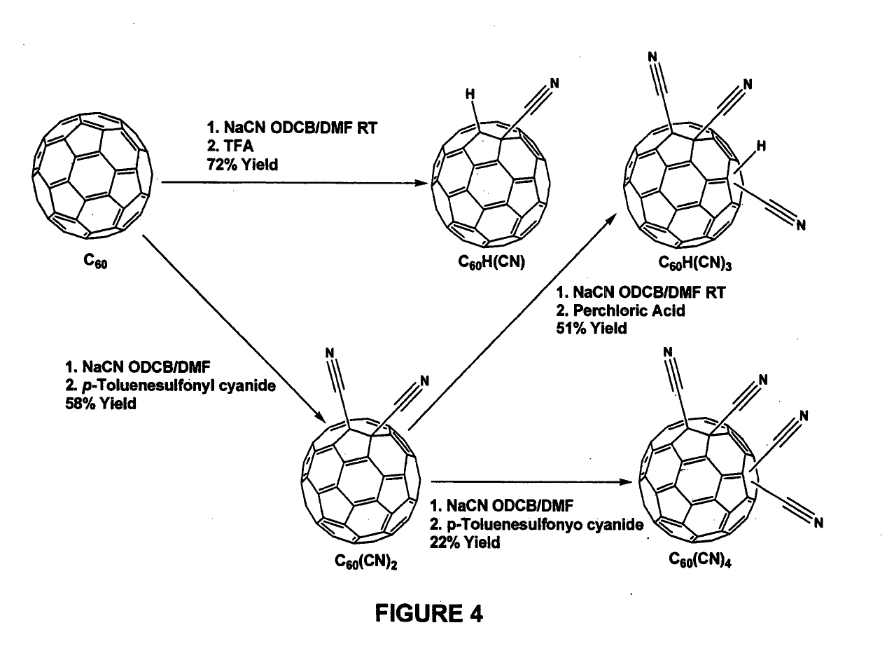

One of the subject materials may be expressed in general form as C₆₀H(CN)ₙ. FIG. 1 illustrates two typical and non-limiting examples, hydrogen mono-cyano fullerene (C₆₀HCN) and hydrogen tri-cyano fullerene (C₆₀H(CN)₃) (see FIG. 4 for additional examples). It must be stressed that fullerenes come in other forms than the common C₆₀ species and that these other fullerenes (C₂₀, C₇₀, C₇₆, C₈₄, C₈₆, and the like) and equivalent hydrogen cyano derivatives are also within the realm of this disclosure. The composition of HCF in a host polymer can be in an extremely wide range (which differs dramatically from existing acid sources utilized in PCMs), but preferably from about 0.01 wt % to about 80 wt %. Again, HCF can be either blended in the host polymer or chemically attached to it.

The exemplary compounds C₆₀H(CN), C₆₀H(CN)₃, C₆₀(CN)₂, and C₆₀(CN)₄ were synthesized according the synthesis scheme shown in FIG. 4 (see below in the “Examples” section for details).

Mixing Agent-Poly(Ethylene Oxide) Attached Fullerenes

The mixing agents which promote a blending of the hydrogen cyano fullerenes into a host polymer are comprised of poly(ethylene oxide) attached fullerenes. These materials may be expressed as C₆₀{(NCH₂CH₂O)ₙCH₃}ₘ and C₆₀{CH₂C₆H₄O(CH₂CH₂O)ₙCH₃}ₘ, wherein “n” and “m” range from 1 to about 45 and from 1 to about 8 or greater, respectively. FIGS. 2 and 3 illustrate some non-limiting examples. The actual chemical linkage of the poly(ethylene oxide) moiety to the fullerene may vary as long as the linkage means does not interfere with the proper functioning and structural integrity of the generated PCM. In general, FIG. 2 illustrates nitrogen facilitated linkages to generate mono and di poly(ethylene oxide) derivatives of fullerene (mono- and di-C₆₀ poly(ethylene oxide) (PEOC₆₀), respectively). FIG. 3 depicts phenyl linkages from multiple poly(ethylene oxide)s to a C₆₀ poly(ethylene oxide) (PEOC₆₀) core. Again, it is stressed that fullerenes come in other forms than the common C₆₀ species and that these other fullerenes (C₂₀, C₇₀, C₇₆, C₈₄, C₈₆, and the like) and equivalent poly(ethylene oxide) derivatives are also within the realm of this disclosure.

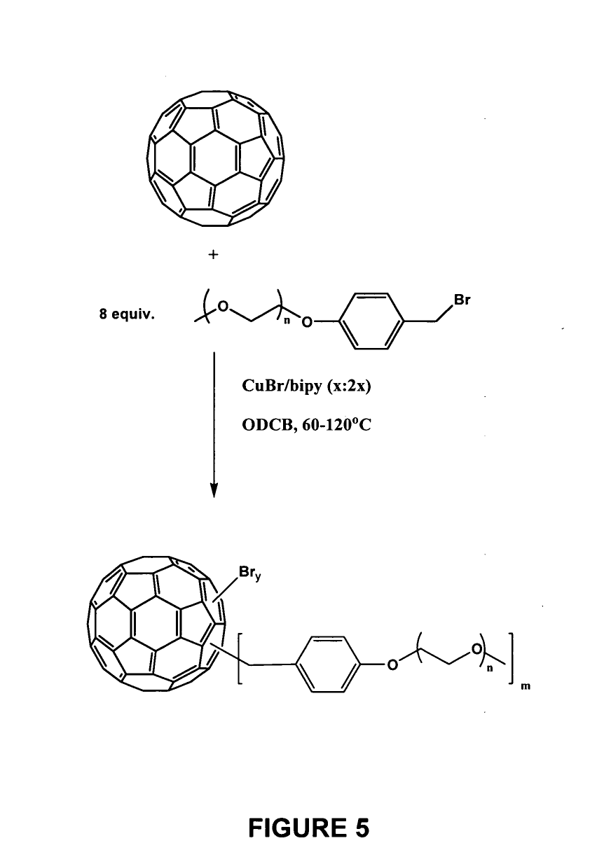

The exemplary C₆₀{CH₂C₆H₄O(CH₂CH₂O)ₙCH₃}ₘ (multi-PEO fullerene [PEOₘC₆₀] derivatives with various length sizes and numbers of PEOₘ chains) molecules were designed and synthesized by atom transfer radical addition (ATRA) reactions (see FIG. 5). It is noted that apparently a limited amount of bromine is incorporated into the final fullerene compounds (the bromine is not indicated in the FIG. 3 structure since, apparently, it is the PEOₘ chains that produce the mixing agent's blending properties and not the small amount of bromine).

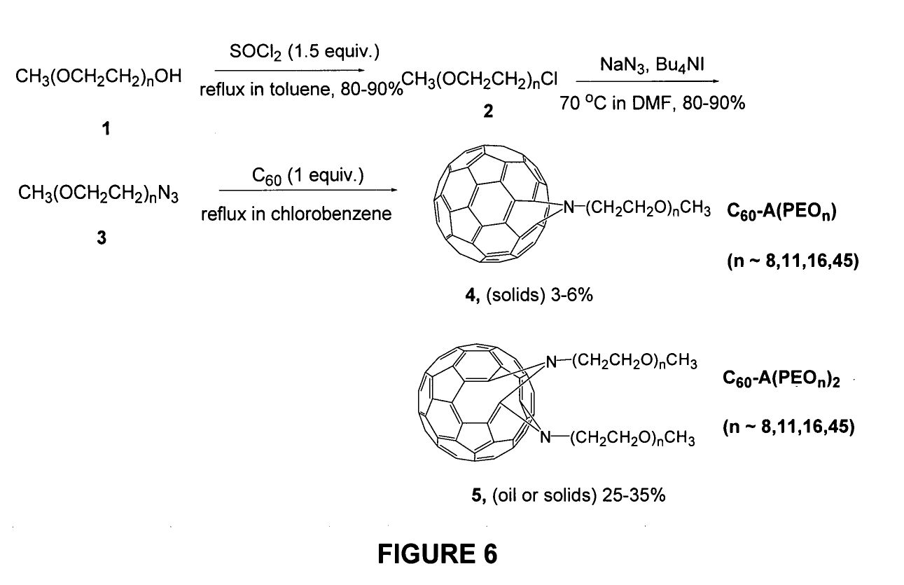

The exemplary C₆₀{(NCH₂CH₂O)ₙCH₃}ₘ molecules, made with various length of PEO chain, were synthesized by azide addition of PEO-azide to fullerene (as seen in FIG. 6). The synthesis followed the procedure from literature. [Hawker, C. J., Saville, P. M., and White, J. W., J. Org. Chem. 1994, 59, 3503 and Huang, X. D., Goh, S. H., and Lee, S. Y., Macromol. Chem. Phys. 2000, 201, 2660] However, unlike those fullerene azide addition reactions, in which mono-azide addition products are always the major products, here we found bis-azide addition products were the major products in all the reactions. Only trace amount of mono-azide addition products were detected (see below for details).

Host Polymer

The host polymers in which hydrogen cyano fullerenes (HCF) are mixed (and, if selected, also one or more suitable fullerene derivatized mixing agents) to compose a PCM can be any polymers as long as they are thermally, chemically, and mechanically stable, and durable when mixed with HCF under typical fuel cell operation conditions. They can be either proton conductive or non-conductive. The examples include NAFION (DuPont, specifically a copolymer of tetrafluoroethylene and perfluoro-3,6-dioxa-4-methyl-7-octenesulfonyl fluoride in acid or ionomer form), poly(arylene ether sulfone), poly(phosphazines), polyethers, poly(vinyl pyrrolidone), poly(phenylene ether), and other equivalent materials, including polymers comprised of perfluoro polymer sulfonic acid in which perfluoro sulfonic acid chains are attached to perfluoroethylene polymer as side chains.

### EXAMPLES

### Example 1

### Preparation of the Acid Source/Proton-Source Agent (Hydrogen Cyano Fullerenes)

Again, C₆₀H(CN) and C₆₀(CN)₂ were synthesized according the literature (Keshavarz, M., Knight, Srdanov, G, and Wudl F., JACS 1995, 11371).

In particular, for the preparation of C₆₀H(CN)₃ a degassed solution of NaCN (20 mg, 1.2 eq.) in DMF (20 mL) was added to a degassed solution of C₆₀(CN)₂ (260 mg, 0.34 mmol.) in ODCB (30 mL) via canula at room temperature. After being stirred 3 minutes, the resultant deep green solution was treated with percholoric acid (0.25 mL). After 30 minutes, the brown mixture was concentrated and the solid obtained was chromatographed on silica gel (CS₂/Toluene (1:3)), C₆₀H(CN)₃ was dissolved in ODCB and crystallized by adding ethyl ether or methanol (51% yield). It is noted that during the synthesis of C₆₀H(CN)₃, that the acidity of trifluoroacetic acid (pKa 0.52) is not strong enough to protonate the C₆₀(CN)₃ and a stronger acid like perchloric acid (pKa: −1.6) was needed to protonate efficiently this anion. This approach made it possible to obtain C₆₀H(CN)₃ in a 51% yield (double that obtained from TFA).

For the preparation of C₆₀(CN)₄ degassed solution of NaCN (30 mg, 1.2 eq.) in DMF (40 mL) was added to a degassed solution of C₆₀(CN)₂ (400 mg, 0.52 mmol.) in ODCB (60 mL) via canula at room temperature under N₂. After being stirred 3 minutes, a degassed solution of p-toluenesulfonyl cyanide (189 mg, 2 eq.) in toluene (30 mL) was added via canula to the resultant deep green solution. After 4 hours, the brown mixture was concentrated and the solid obtained was chromatographied on silica gel (CS₂/Toluene (1:3)). The solvents were removed and C₆₀(CN)₄ was dissolved in ODCB and crystallized by adding ethyl ether or methanol (22% yield).

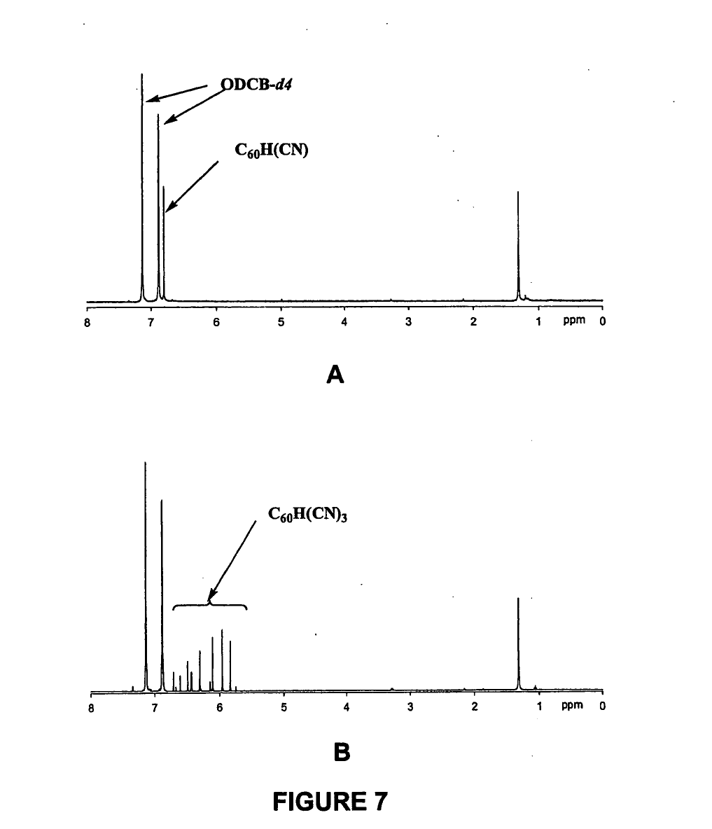

Characterization of C₆₀H(CN)₃ and C₆₀(CN)₄: ¹H NMR: By NMR, the characterization of C₆₀H(CN)₃ and C₆₀(CN)₄ are more difficult than for C₆₀H(CN) and C₆₀(CN)₂ because they were obtained in the form of different regioisomers. As seen in FIG. 7A, the NMR ¹H spectrum of C₆₀H(CN) gives one singlet at 6.65 ppm because there is only one isomer. In the case of C₆₀H(CN)₃ (see FIG. 7B), thirteen singlets appear between 5.8 and 6.5 ppm corresponding to the proton of each of the different regioisomers.

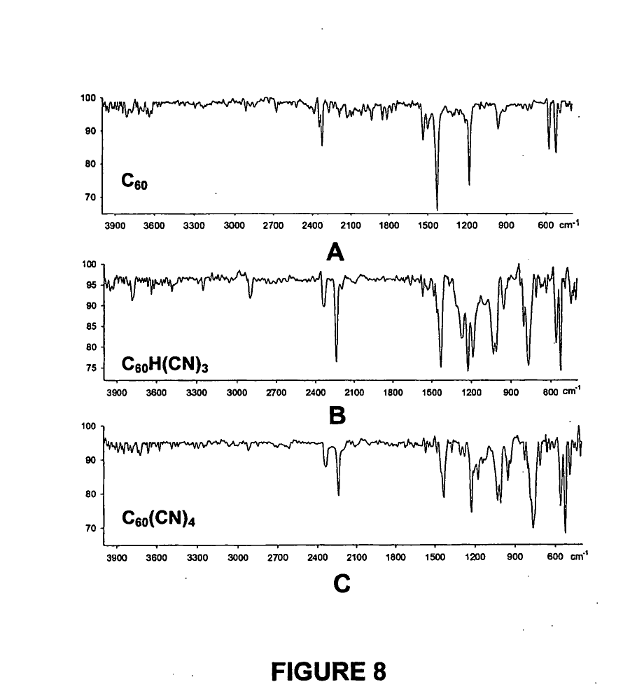

IR: As seen in FIG. 8, the drift IR spectra of C₆₀H(CN)₃ (FIG. 8B) and C₆₀(CN)₄ (FIG. 8C) show clearly the cyano group (2232 cm⁻¹) that does not appear for C₆₀ (1430, 1180, 540 and 525 cm⁻¹) (FIG. 8A).

Mass spectrum (not shown): The negative MALDI-TOF spectra of C₆₀H(CN)₃ and C₆₀(CN)₄ show mainly the parent peaks.

Results from differential pulse voltammetry measurements of subject compounds (not shown): As the number of cyano groups on the C₆₀ derivatives increased, it became easier to reduce the compounds. Hence, the attachment of four cyano groups causes a positive shift of 320 mV, compared to C₆₀. The hydro cyano fullerene derivatives compounds are not soluble in hydroxylic solvents (such as water, ammonia, acetic acid, ethanol, etc.), making a direct titration impossible. The method used in the literature to determinate the pKa of hydro fullerene(s) is through voltammety. In order to obtain information about the acidity of C₆₀H(CN)ₓ, different bases were added to solutions of these compounds. If the acidity of C₆₀H(CN)ₓ was strong enough to protonate the base added and form C₆₀(CN)ₓ, the first reduction peak for C₆₀H(CN)ₓ should decrease in height because C₆₀(CN)ₓ is much more difficult to reduce, its first step of reduction being close to the second reduction step of C₆₀H(CN)ₓ. Four bases were used: the sodium salts of acetic acid, chlroroacetic acid, dichloroacetic acid and trifluoroacetic acid. In water, the pKa values of the acids are 4.75, 2.87, 1.35 and 0.52, respectively. The addition of 1 mol of acetate or chloroacetate in DMSO per mol of C₆₀H(CN) in ODCB resulted in complete disappearance of the first reduction peak of C₆₀H(CN), signifying that C₆₀H(CN) is a much stronger acid than chloroacetic acid. By contrast, addition of 1 equiv of sodium dichloroacetate caused only a 20% reduction in the height of the C₆₀H(CN) peak and no decrease with added trifluoroacetate. This implies that the pKa of C₆₀H(CN) is between chlroroacetic acid (pKa: 2.87) and dichloroacetic acid (pKa: 1.35). The same experiments were performed with C₆₀H(CN)₃. For this compound, the addition of 1 mol of acetate, chloroacetate or dichloroacetate per mol of C₆₀H(CN)₃, resulted in complete disappearance of the first reduction peak of C₆₀H(CN)₃, signifying that C₆₀H(CN)₃ is a much stronger acid than dichloroacetic acid (pKa: 1.35) but less than trifluoroacetic acid (pKa: 0.52) since only half of the C₆₀H(CN)₃ reduction peak disappeared. Thus, C₆₀H(CN)₃ (pKa around 0.7) is a much stronger acid than C₆₀H(CN) (pKa around 2.5).

### Example 2

### Preparation of the Mixing Agent (Poly(Ethylene Oxide) Attached Fullerenes)

Poly(ethylene oxide) monomethyl ethers (for example, where n˜3, 8, 12, 17, and 45) were functionalized with benzyl bromide in three steps as shown immediately below in Scheme 1:

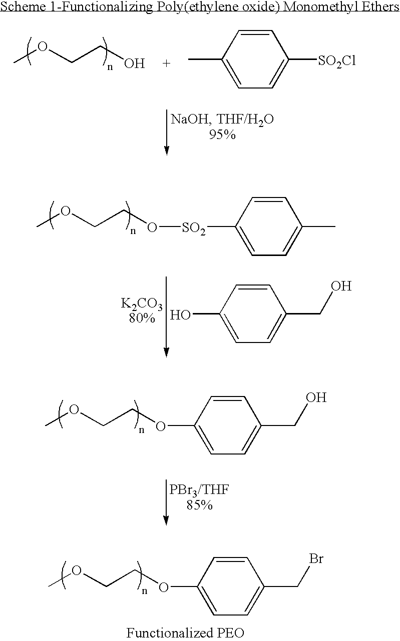

As seen in FIG. 5, in the ATRA step, the fullerene was first dissolved in o-dichlorobenzene (ODCB) in a pressure vessel, then 8 equivalents of PEO-benzylbromide (one equivalent yields a mono-PEO final product and the like) and 2,2′-bipyridine were added and the solution was degassed for 10 minutes. After 8 equivalents of Cu(I)Br was added, the vessel was sealed and heated to 110° C. for 24 h until a green precipitate formed. Air was bubbled through the reaction mixture to precipitate un-reacted copper (I) complex. Upon filtration, the solution was concentrated and precipitated into 200 ml of ether. The product, with “n” final PEO chains and “y” bromines, was collected by filtration as a brown oil or solid (final yield was ˜90%).

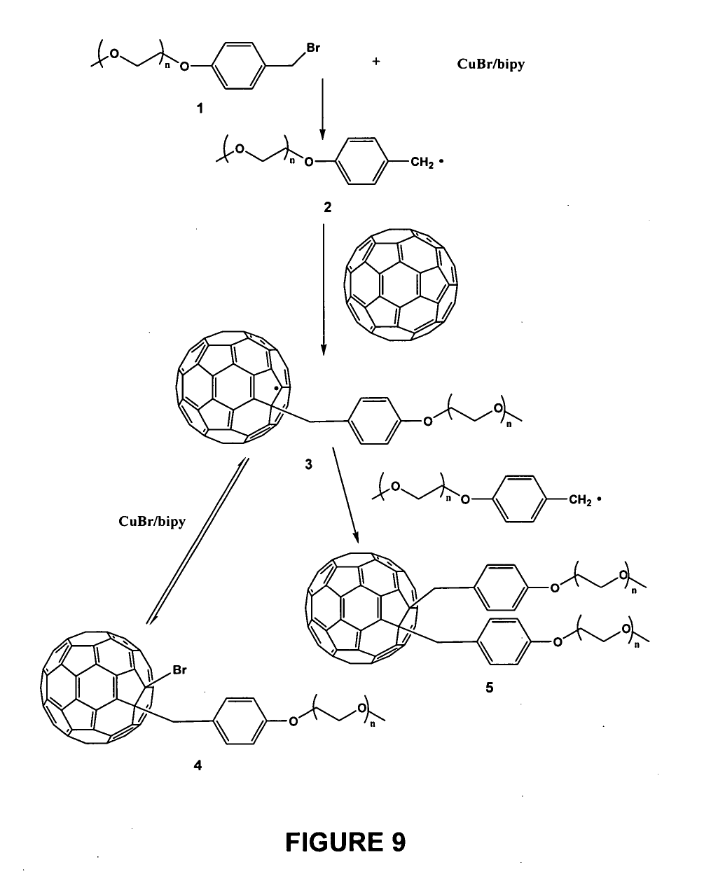

The proposed mechanism for the reaction is presented in FIG. 9.

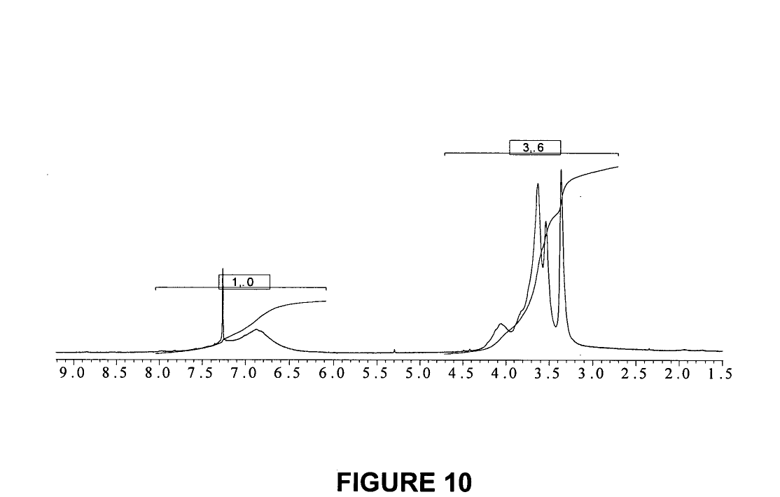

¹H-NMR spectra of multi-PEO fullerenes in CDCl₃ (FIG. 10) give very broad signals, no signal of fullerene carbon was observed from ¹³C-NMR spectra. Both indicates the existence of radicals and (or) random additions of PEG chains to fullerene molecules.

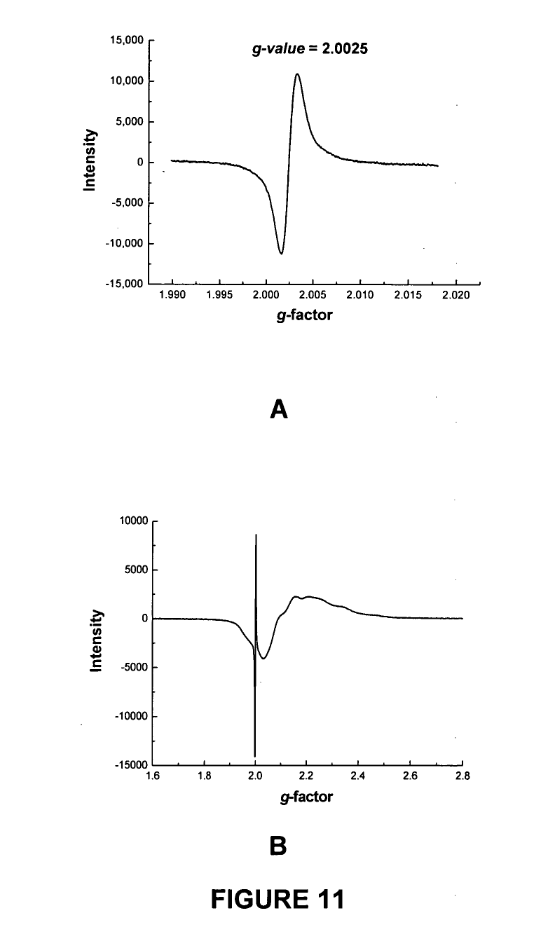

As seen in FIGS. 11A and 11B, two types of radicals were discovered from EPR study of (PEO₃)ₘC₆₀ solid and solution samples. The results indicate that some (PEO₃)ₘC₆₀ molecules (<1% from calculation) have radicals and small amount of Cu(II) residue still left in the sample (both organic (FIG. 11A) and transitional metal (FIG. 11B) radical signals).

TABLE 1
Elemental analysis result of (PEO₃)ₘC₆₀

| Sample ID | % C | % H | % Br | % Cu |
|---|---|---|---|---|
| C60TEGN | 72.82 | 5.64 | 1.57 | 0.79 |

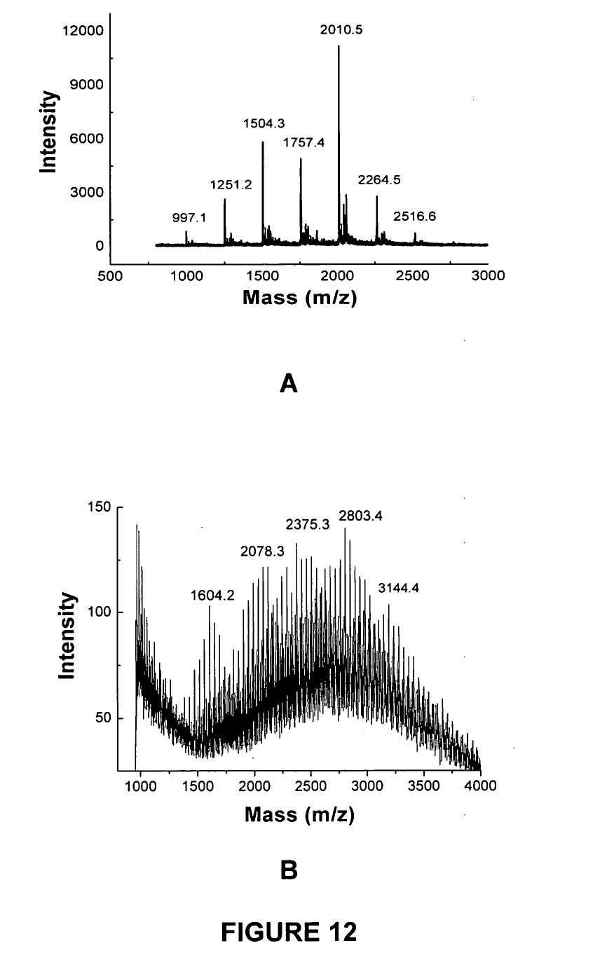

Elemental analysis of (PEO₃)ₘC₆₀ (Table 1, above) confirmed the existence of Br and Cu(II) residues. Calculation based on the ratio of H gives 5 PEO₃ chains attached to each fullerene molecule by average, which is confirmed by MALDI spectrum of (PEO₃)ₘC₆₀ (see FIG. 12 with (PEO₃)ₘC₆₀ (FIG. 12A) and (PEO₈)ₘC₆₀ (FIG. 12B)). When longer PEO chains were used in the reaction, fewer numbers of PEOs were reacted to each fullerene molecule probably due to the steric hindrance. To further remove the Cu(II) residue, (PEO₃)ₘC₆₀ was dissolved in CHCl₃ and bubbled with H₂S for 4 hours. After this process, the Cu(II) EPR signal disappeared and the fullerene radical signal had no change.

One can see from the MALDI data of (PEO₃)ₘC₆₀ (FIG. 12A) and (PEO₈)ₘC₆₀ (FIG. 12B) that m is ranged from 1 to 8, with an average number about 4 to 5. From the elemental analysis of (PEO₃)ₘC₆₀, there is 1.6% bromine, which equals about 0.4 bromine (or y˜0.4) per PEO fullerene, on average. The existence of bromine can be explained by the reactions mechanism (FIG. 9), when a PEO-benzyl radical (compound 2) reacted with a fullerene double bond, a fullerene radical (compound 3) formed. This fullerene radical reacted with either another PEO-benzyl radical to give compound 5 or reversible abstracted bromine from the copper complex (or perhaps compound 1) to give compound 4. Again, any possible bromine is not shown in FIG. 3 since the bromine had no obvious effect on the final PCMs.

Specifically, the exemplary azide addition fullerenes or C₆₀{(NCH₂CH₂O)ₙCH₃}ₘ molecules, made with various length of PEO chains, were synthesized by azide addition of PEO-azide to fullerene (as seen in FIG. 6). As indicated above, the synthesis followed the procedure from literature. [Hawker, C. J., Saville, P. M., and White, J. W., J. Org. Chem. 1994, 59, 3503 and Huang, X. D., Goh, S. H., and Lee, S. Y., Macromol. Chem. Phys. 2000, 201, 2660.] Once again, unlike those fullerene azide addition reactions, in which mono-azide addition products are always the major products, here we found bis-azide addition products (compounds 5 in FIG. 6 or the Di PEOC₆₀ with n=8, 11, 16, and 45 seen FIG. 2) were the major products in all the reactions. Only trace amount of mono-azide addition products (compounds 4 in FIG. 6 or the Mono PEOC₆₀ with n=8, 11, 16, and 45 seen FIG. 2) were detected. The structure of compounds 4 and 5 were confirmed by ¹H-NMR, ¹³C-NMR and elemental analysis. DSC and TGA studies showed that these materials are thermally stable up to 220° C.

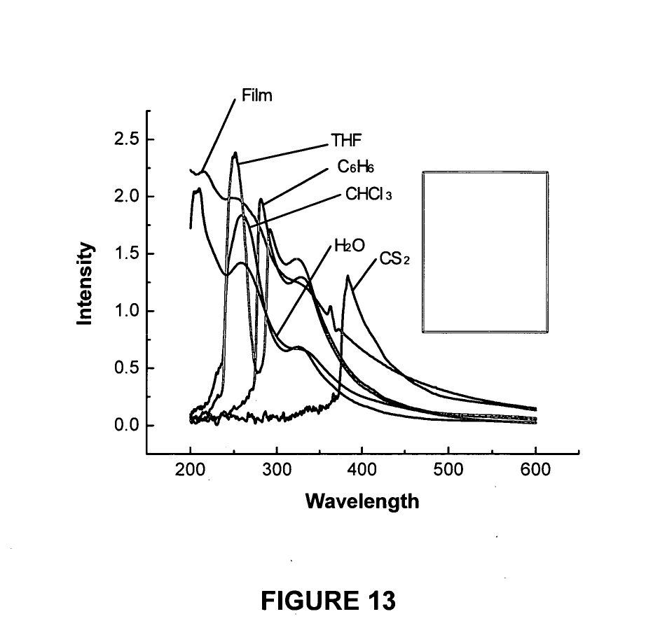

The bis-azide addition fullerenes are very soluble in common organic solvents such as toluene, methylene chloride, chloroform, THF and methanol. Di (PEO₁₆)C₆₀ and Di (PEO₄₅)C₆₀ are soluble in water. UV-VIS spectra of Di (PEO₁₆)C₆₀ in various solvents and thin film are shown in FIG. 13. The large shifts of UV absorption in different solvents strongly indicate aggregation of these molecules.

### Example 3

### Method #1 for Fullerene Composite Proton Conducting Membrane/Film Preparations

1. Appropriate amounts of the C₆₀H(CN)₃ (it is noted that any hydrogen cyano fullerene may be used for the exemplary C₆₀H(CN)₃ proton-source agent) and, if desired, PEOₘC₆₀ (mixing agent) were weighed and added to ˜5 g of Chlorobenzene.

2. Required amount of any desired PEO (host polymer) was added to ˜5 g of chlorobenzene in a separate container.

3. These mixtures were sonicated (˜10 mins).

4. They were then stirred in an 85° C. oil bath for 1˜2 hours.

5. After confirming complete dissolution, they were mixed together and stirred for about 1 hour at 85° C. in an oil bath. (PEO tends to gel if the mixing in the earlier stages is not proper.)

6. The resultant homogeneous solution was poured into a TEFLON dish and dried in a 120° C. oven for 2-3 hours to get a composite film.

### Example 4

### Method #2 for Fullerene Composite Membrane/Film Preparations

Generally, and for exemplary purposes only, four different fullerenes were mixed in a NAFION solution to prepare a solution cast fullerene composite membrane/film: 1) C₆₀; 2) PEOC₆₀; 3) polyhydroxyl fullerene (C₆₀(OH)ₙ, (n=10 to 12)); and 4) hydrogen cyano fullerene C₆₀H(CN)ₙ (in particular, hydrogen tri-cyano fullerene, C₆₀H(CN)₃). C₆₀ and the NAFION solution were purchased from standard sources, PEOC₆₀ and hydrogen tri-cyano fullerene were prepared as described herein, and C₆₀(OH)ₙ was synthesized according to the literature. [L. Y. Chiang, L-Y. Wang, J. W. Swirczewski, S. Soled, S. Cameron, Efficient Synthesis of Polyhydroxylated Fullerene Derivatives via Hydrolysis of Polycyclosulfated Precursors, J. Org. Chem., 59 (1994) 3960, which is herein incorporated by reference.]

Various common solvents were obtained from standard chemical supply companies and include, but are not limited to: dimethyl acetamide; dimethyl formamide; benzene (aromatic carbon solvent); and various chlorinated benzenes, including dichlorobenzene, ortho-dichlorobenzene and chlorobenzene (chlorinated aromatic carbon solvents).

4.1 Preparation of C₆₀-NAFION Composite Membranes

13 g of 5 wt % NAFION solution in isopropanol obtained from Alfa Aeser was dried in a TEFLON dish at 80° C. in an oven purged with air at 200 mL/min for 8 to 10 hours. The amount of dry NAFION obtained was weighed after drying the obtained polymer at 105° C. under vacuum for 1 hour. The yield was 0.650 g of a dry NAFION membrane. From this, 0.6094 g of the dry NAFION membrane was cut into small pieces and dissolved in 10 mL of dry dimethyl acetamide at 80˜90° C. After the NAFION dissolved completely, 2 mL of ortho-dichlorobenzene was added to the solution at 80˜90° C. with vigorous stirring for half an hour. Simultaneously, 6.15 mg of C₆₀ (˜1 wt %) was dissolved in 2 mL of chlorobenzene at room temperature. The C₆₀ solution in chlorobenzene was added to the NAFION solution while simultaneously adding 4.0 mL of chlorobenzene at 80˜90° C. with vigorous stirring for 4 hours. The purple solution turned clear brown. The mixture was then poured into a 6.4 cm diameter TEFLON casting dish. The membrane/film was cast in an oven at 120° C. purged with air at 200 mL/min overnight. The membrane/film was annealed at 170° C., by ramping the temperature to 150° C. for 1 hour and then at 170° C. for 1 hour. The membrane/film in the casting dish was soaked in water and the peeled from the casting dish.

4.2 Preparation of C₆₀(OH N-NAFION Composite Membranes

0.650 g of a dry NAFION membrane obtained from the NAFION isopropanol solution described immediately above in 4.1 was cut into small pieces and dissolved in 10 mL of dry dimethyl acetamide at 80° C. 6.5 mg C₆₀(OH)ₙ was dissolved in 5 mL of dry dimethyl acetamide at room temperature. This solution in the dimethyl acetamide was added to the NAFION solution in the dimethyl acetamide at 80° C. while stirring. The mixture was stirred for approximately half an hour at 80° C. and then poured into a 6.4 cm diameter TEFLON casting dish. The membrane/film was cast in an oven at 120° C. purged with air at 200 mL/min overnight. The membrane was annealed at 170° C., by ramping the temperature to 150° C. for 1 hour and then at 170° C. for 1 hour. The membrane/film in the casting dish was soaked in water and then peeled from the casting dish.

4.3 Preparation of C₆₀H(CN)₃-NAFION Composite Membranes

0.650 g of a dry NAFION membrane obtained from the NAFION isopropanol solution described above in 4.1 was cut into small pieces and dissolved in 10 mL of dry dimethyl acetamide at 80° C. 6.5 mg C₆₀H(CN)₃ was dissolved in 5 mL of dry dimethyl acetamide at room temperature. This solution in the dimethyl acetamide was added to the NAFION solution in the dimethyl acetamide at 80° C. while stirring. The mixture was stirred for approximately half an hour at 80° C. and then poured into a 6.4 cm diameter TEFLON casting dish. The membrane/film was cast in an oven at 120° C. purged with air at 200 mL/min overnight. The membrane/film in the casting dish was soaked in water and then peeled from the casting dish.

4.4 Preparation of C₆₀H(CN)₃-PEOC₆₀-NAFION Composite Membranes

0.650 g of a dry NAFION membrane obtained from the NAFION isopropanol solution described above in 4.1 was cut into small pieces and dissolved in 10 mL of dry dimethyl acetamide at 80° C. 6.5 mg C₆₀H(CN)₃ and 3 mg of PEOC₆₀ were dissolved in 5 mL of dry dimethyl acetamide at room temperature. This mixture was added to the NAFION solution in the dimethyl acetamide at 80° C. while stirring. The mixture was stirred for approximately half an hour at 80° C. and then poured into a 6.4 cm diameter TEFLON casting dish. The membrane/film was cast in an oven at 120° C. purged with air at 200 mL/min overnight. The membrane/film in the casting dish was soaked in water and then peeled from the casting dish.

4.5 Preparation of C₆₀(OH)ₙ Doped NAFION Composite Membranes

NAFION 117, obtained from DuPont, soaked in MeOH was stirred in a solution of C₆₀(OH)ₙ in THF to make a C₆₀(OH)ₙ doped NAFION membrane/film (denoted as C₆₀(OH)ₙ/NAFION). The doped membrane/film was dried in an oven at 80° C. overnight. The loading of the water binding fullerene in the NAFION membrane/film was about 1 wt %.

### Example 5

### Conductivity/Impedance Analysis Procedures for Fullerene Composite Proton Conducting Membrane/Film Preparations Fabricated Utilizing Method #1

An HP LF4192A Impedance Analyzer was used to measure impedance (conductivity). Samples were scanned at frequencies from 0.5 Hz to 11 MHz. The high frequency impedance at zero phase angle was used as the impedance value. For each sample, the polymer film was mounted in a TEFLON fixture having windows for equilibrating with the surrounding atmosphere. The sample films were equilibrated at the required humidity for ˜12 hours. The various humidities were achieved by saturated salt solutions of various appropriate salts. Each resulted in a different humidity in the head space above the solution (a standard technique that is well known in the art). Each sample was suspended (in the TEFLON fixture) above these salt solutions and measured after equilibration. All measurements were two-probe measurements. For the samples, all were at room temperature (i.e. ˜22° C.) and an appropriate humidity (most commonly, humidity was ˜15-17% RH, but other RHs were utilized for some experiments). The conductivity was calculated from the impedance as seen in Equation 1, immediately below.
Conductivity [S/cm]=(1/R)*(L/A) Equation 1

In Equation 1: R [Ohms]=high frequency zero phase angle resistance; L [cm]=length of the conducting film; and A [square cm]=cross sectional area of the conducting film (product of width and thickness of the film for in =plane measurements).

### Example 6

### First PCM Creation and Analysis Experiments for Membranes/Films Fabricated Utilizing Method #1

A specific PCM was prepared (see details above) by mixing poly(ethylene oxide) (70 wt %), hydrogen tri-cyano fullerene (20 wt %), and multiple PEO C₆₀ (in which n=3 and m=5 in FIG. 3) (10 wt %) altogether and through solution casting. Then, the proton conductivity was measured at 30° C. under 20% relative humidity. Similarly, the conductivity of NAFION 117 was also measured as a control. Table 2 summarizes the results.

TABLE 2
Proton Conductivities of PCMs made with the Hydrogen Cyano
Fullerene/Poly(ethylene oxide)/Multiple PEO C₆₀ (Subject Sample) versus
NAFION 117.

| Subject Sample | NAFION 117 |
|---|---|
| σ, S cm⁻¹ | σ, S cm⁻¹ |
| 6 × 10⁻² | 1 × 10⁻³ |

The results (Table 2, above) show more than an order of magnitude higher conductivity for the subject PCM than with the industrial standard NAFION 117 PCM, the control. Additionally, the results shown in Table 2 demonstrate the ability of C₆₀H(CN)₃ to impart conductivity to a non-conducting polymer, such as PEO.

### Example 7

### Summarized Evaluation of C₆₀H(CN)₃ as a Proton Source

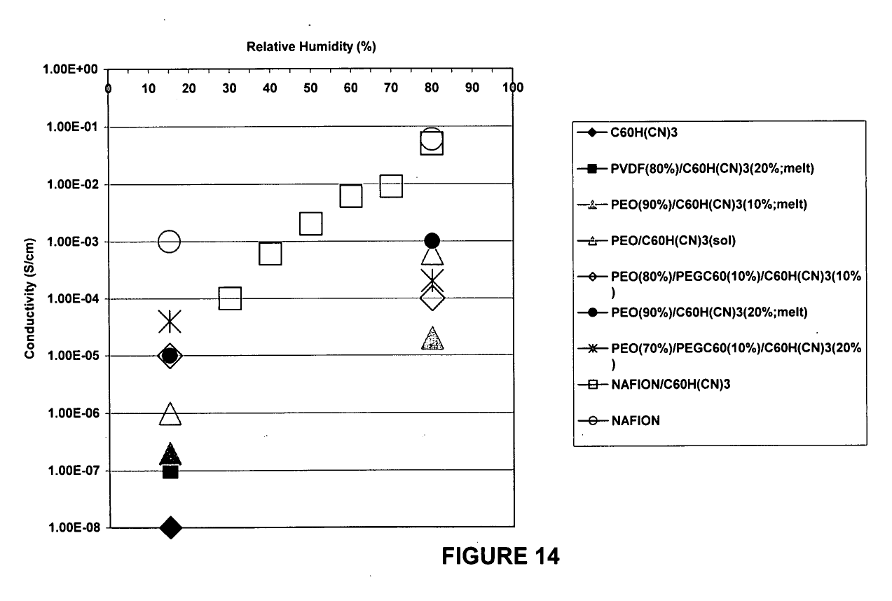

The abilities to “enhance” conductivity or to “impart” conductivity in membrane/film samples were studied using NAFION and other polymers. A summary presentation for the conductivities of the different membranes/films as a function of relative humidity at room temperature appear in FIG. 14.

### Example 8

### Conductivity/Impedance Analysis Procedures for Fullerene Composite Membrane/Film Preparations Fabricated Utilizing Method #2

AC impedance measurements were performed for the membranes/films at 30° C. under 25% of relative humidity in the frequency range of 100 Hz to 2 MHz using a combination of Solartron 1260 FRA and 1287 potentiostat. The relative humidity (RH) was controlled by adjusting the ratio of dry and wet N₂ gas flow, and the exit gas relative humidity was monitored using a humidity probe. The membrane/film was equilibrated under a given RH for several hours prior to the impedance measurements. The resistance associated with the membrane/film at zero phase angle was used to estimate the proton conductivity of the membrane/film using the Equation 1, above. All the membranes/films were treated by 1 M H₂SO₄ at 80° C. for 1 hour and washed in water at room temperature for 1 hour prior to the AC impedance measurements.

### Example 9

### Optical Microgram for Fullerene Composite Membrane/Film Preparations Fabricated Utilizing Method #2

FIG. 15A displays the optical micrograms for the 1 wt % C₆₀(OH)ₙ/NAFION doped membrane/film (on the left) and the 1 wt % C₆₀(OH)ₙ-NAFION cast membrane/film (on the right). The better dispersion of C₆₀(OH)ₙ-NAFION by solution casting Method #2 is demonstrated. FIG. 15B illustrates the effective use of PEOC₆₀ as the mixing agent for the fullerene derivative in the C₆₀H(CN)₃-PEOC₆₀-NAFION composite membrane/film (on the right), compared to the C₆₀H(CN)₃-NAFION composite membrane/film (on the left). The improvement of the dispersion of C₆₀H(CN)₃ in the NAFION polymer matrix by mixing with PEOC₆₀ is apparent.

### Example 10

### AC Impedance Measurements for Membranes/Films Fabricated Utilizing Method #2

Table 3 summarizes the proton conductivities of the fullerene composite membranes/films fabricated by means of Method #2 at 30° C. under 25% relative humidity.

TABLE 3
The Proton Conductivities of Composite Membranes/Films under 25% RH
Fabricated Utilizing Method #2

| Composite | |
|---|---|
| Membranes/Films | σ, S cm⁻¹ |
| C₆₀-NAFION | 4.5 × 10⁻³ |
| C₆₀(OH)ₙ-NAFION | 2.1 × 10⁻³ |
| C₆₀H(CN)₃-NAFION | 6 × 10⁻³ |
| C₆₀H(CN)₃-PEOC₆₀- | 1 × 10⁻² |
| NAFION | |
| NAFION 117 | 1.2 × 10⁻³ |

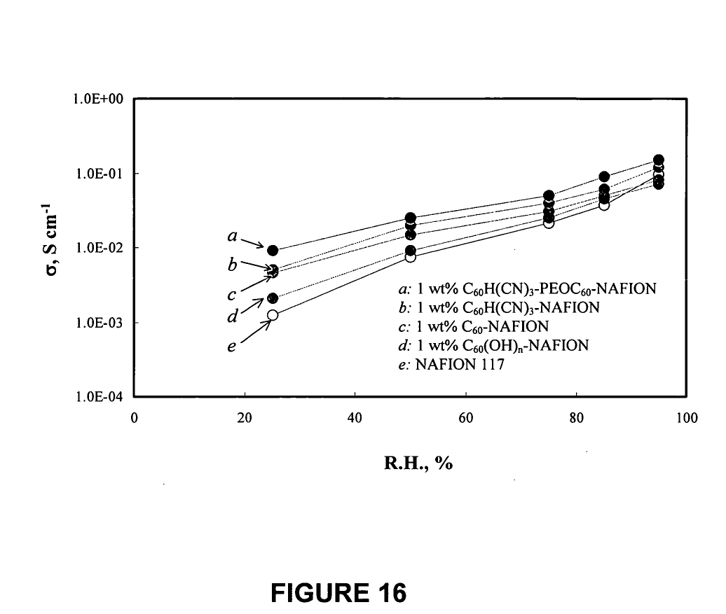

All fullerene-NAFION composite membranes/films shown in Table 3 exhibit higher conductivities than NAFION 117 under 25% RH. Among them, the C₆₀H(CN)₃ composites show the highest conductivities. Furthermore, the improvement of the conductivity by mixing with PEOC₆₀ in the composite is demonstrated. FIG. 16 illustrates the proton conductivities of all the fullerene-NAFION composite membranes/film fabricated utilizing Method #2 as a function of relative humidity.

### Example 11

### Extraction Test for Membranes/Films Fabricated Utilizing Method #2

Extraction of the fullerene out of the NAFION composite membranes/films fabricated utilizing Method #2 was investigated. Two sample membranes/films were used: C₆₀(OH)ₙ/NAFION (doped) and C₆₀(OH)ₙ-NAFION (cast). The two membranes/films were soaked in water at 30° C. for 120 hours without stirring. For the former membrane (doped), the weight difference in the composite membrane/film before and after the soaking in water was measured to estimate the amount of C₆₀(OH)ₙ extracted out of the membrane into water. As to the latter (cast), a UV-Vis spectrum of the extracted solution was obtained to estimate the amount of C₆₀(OH)ₙ extracted out of the membrane which was determined from its absorbance intensity. Table 4 lists the extracted amounts for the both membranes/films.

TABLE 4
Extracted Amounts of C₆₀(OH)ₙ for the Doped and Solution Cast
Composite Membranes/Film (fabricated utilizing Method #2) into Water at
30° C. after 120 hours

| | C₆₀(OH)ₙ/NAFION | C₆₀(OH)ₙ- |
|---|---|---|
| | (doped) | NAFION (cast) |
| Percentage of extracted | 67% | <1% |
| fullerene originally | | |
| mixed in NAFION membrane | | |

The fullerene composite membrane/film obtained from the subject invention, C₆₀(OH)ₙ-NAFION (cast utilizing Method #2), shows little extraction (<1%) of the fullerene out of the NAFION composite membrane/film, demonstrating the significantly improved stability of the fullerene membranes/films generated by the Method #2 solution casting procedure.

### Example 12

### Optical Microgram for Composite Membrane/Film Preparations with and without PEOC₆₀ Fabricated Utilizing Method #2

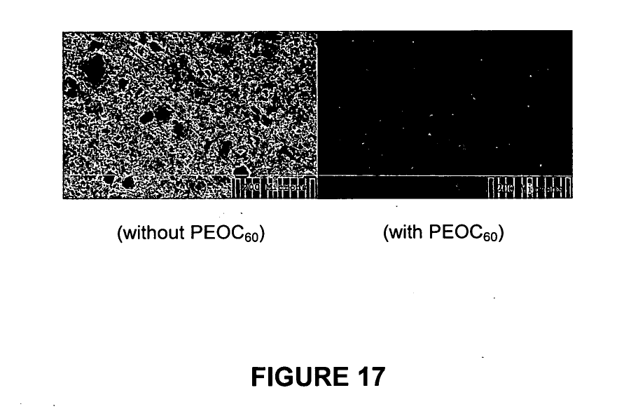

FIG. 17 displays the optical micrograms for the 1 wt % C₆₀-NAFION membrane/film (on the left) and the 1 wt % C₆₀-0.5 wt % PEOC₆₀-NAFION membrane/film (on the right). Clearly, better dispersion is achieved for NAFION with the presence of PEOC₆₀.

All references contained herein are incorporated herein by reference in their entireties.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a composition or method to address each and every problem sought to be solved by the present invention, for it to be encompassed by the present claims. Furthermore, no element, composition, or method step in the present disclosure is intended to be dedicated to the public regardless of whether the element, composition, or method step is explicitly recited in the claims. No claim element herein is to be construed under the provisions of 35 U.S.C. 112, sixth paragraph, unless the element is expressly recited using the phrase “means for.”

What is claimed is:

1. A method of fabricating a fullerene composite membrane, comprising the steps:
a) a fullerene is dissolved in a first solvent producing a first solution;
b) a polymer is dissolved in a second solvent producing a second solution;
c) said first and said second solutions are mixed together producing a third solution; and
d) said third solution is cast to generate the composite membrane.

2. A method according to claim 1, where said first and said second solvents are identical.

3. A method according to claim 1, wherein the composite membrane is a proton conducting membrane.

4. A method according to claim 1, wherein said fullerene is C₆₀.

5. A method according to claim 1, wherein said fullerene comprises a chemically functionalized fullerene.

6. A method according to claim 1, wherein said fullerene comprises a combination of C₆₀ and a chemically functionalized fullerene.

7. A method according to claim 1, wherein said fullerene comprises a combination of more than one chemically functionalized fullerene.

8. A method according to claim 1, wherein said polymer comprises a proton conducting membrane.

9. A method according to claim 1, wherein said polymer comprises a perfluoro polymer sulfonic acid in which perfluoro sulfonic acid chains are attached to perfluoroethylene polymer as side chains.

10. A method according to claim 1, wherein said polymer comprises a copolymer of tetrafluoroethylene and perfluoro-3,6-dioxa-4-methyl-7-octenesulfonyl fluoride in acid or ionomer form.

11. A method according to claim 1, wherein said polymer comprises NAFION in acid or ionomer form.

12. A method according to claim 1, wherein said first solvent is selected from a group consisting of dimethyl acetamide, a mixture of dimethyl acetamide and an aromatic carbon solvent, and a chlorinated aromatic carbon solvent and said second solvent is dimethyl acetamide.

13. A method according to claim 9, wherein said first solvent is selected from a group consisting of dimethyl acetamide, a mixture of dimethyl acetamide and an aromatic carbon solvent, and a chlorinated aromatic carbon solvent and said second solvent is dimethyl acetamide for said perfluoro polymer sulfonic acid.

14. A method according to claim 11, wherein said first solvent is selected from a group consisting of dimethyl acetamide, a mixture of dimethyl acetamide and an aromatic carbon solvent, and a chlorinated aromatic carbon solvent and said second solvent is dimethyl acetamide for said NAFION.

15. A method according to claim 1, wherein said first and said second solvents are both dimethyl acetamide.

16. A method according to claim 1, wherein said first and said second solvents are both dimethyl formamide.

17. A method according to claim 9, wherein said first and said second solvents are both dimethyl acetamide.

18. A method according to claim 11, wherein said first and said second solvents are both dimethyl acetamide.

19. A method according to claim 11, wherein said first solvent is selected from a group consisting of dimethyl acetamide, a mixture of dimethyl acetamide and an aromatic carbon solvent, and a chlorinated aromatic carbon solvent and said second solvent is dimethyl acetamide.

20. A method according to claim 11, the said first and said second solvents are both dimethyl formamide.

21. A method according to claim 1, wherein said first solvent is a mixture of dimethyl acetamide and an aromatic carbon solvent.

22. A method according to claim 1, wherein said first solvent is a mixture of dimethyl acetamide and a solvent selected from a group consisting of a chloro aromatic carbon solvent and ortho-dichlorobenzene.

23. A method according to claim 1, wherein said first solvent is a mixture of dimethyl acetamide and a solvent selected from a group consisting of dichlorobenzene and ortho-dichlorobenzene.

24. A method according to claim 9, wherein said first solvent is an aromatic carbon solvent and said second solvent is dimethyl acetamide for said perfluoro polymer sulfonic acid.

25. A method according to claim 11, wherein said first solvent is an aromatic carbon solvent and said second solvent is dimethyl acetamide for said NAFION.

26. A method according to claim 9, wherein said first solvent is a chloro aromatic carbon solvent and said second solvent is dimethyl acetamide for said perfluoro polymer sulfonic acid.

27. A method according to claim 11, wherein said first solvent is a chloro aromatic carbon solvent and said second solvent is dimethyl acetamide for said NAFION.

28. A method according to claim 11, wherein said first solvent is a mixture of dimethyl acetamide and di-chloro benzene and said second solvent is dimethyl acetamide for said NAFION.

29. A method according to claim 1, wherein PEOC₆₀ is added to facilitate mixing of said fullerene with said polymer, wherein said PEOC₆₀ is C₆₀ attached to one or more ethylene oxide chains, wherein the number of ethylene oxide units in each said chain is one or more.

30. A method according to claim 9, wherein PEOC₆₀ is added to facilitate mixing of said fullerene with said perfluoro polymer sulfonic acid, wherein said PEOC₆₀ is C₆₀ attached to one or more of ethylene oxide chains, wherein the number of ethylene oxide units in each said chain is one or more.

31. A method according to claim 11, wherein PEOC₆₀ is added to facilitate mixing of said fullerene with said NAFION, wherein said PEOC₆₀ is C₆₀ attached to one or more of ethylene oxide chains, wherein the number of ethylene oxide units in each said chain is one or more.

32. A method according to claim 12, wherein PEOC₆₀ is added to facilitate mixing of said fullerene with said polymer, wherein said PEOC₆₀ is C₆₀ attached to one or more of ethylene oxide chains, wherein the number of ethylene oxide units in each said chain is one or more.

33. A method according to claim 13, wherein PEOC₆₀ is added to facilitate mixing of said fullerene with said perfluoro polymer sulfonic acid, wherein said PEOC₆₀ is C₆₀ attached to one or more of ethylene oxide chains, wherein the number of ethylene oxide units in each said chain is one or more.

34. A method according to claim 14, wherein PEOC₆₀ is added to facilitate mixing of said fullerene with said NAFION, wherein said PEOC₆₀ is C₆₀ attached to one or more of ethylene oxide chains, wherein the number of ethylene oxide units in each said chain is one or more.

35. A proton conducting membrane comprised of a functionalized fullerene and said polymer, wherein the membrane is fabricated by the method in claim 1.

36. A proton conducting membrane comprised of a functionalized fullerene and said perfluoro polymer sulfonic acid, wherein the membrane is fabricated by the method in claim 9.

37. A proton conducting membrane comprised of a functionalized fullerene and said NAFION, wherein the membrane is fabricated by the method in claim 11.

38. A proton conducting membrane comprised of a functionalized fullerene and said polymer, wherein the membrane is fabricated by the method in claim 12.

39. A proton conducting membrane comprised of a functionalized fullerene and said perfluoro polymer sulfonic acid, wherein the membrane is fabricated by the method in claim 13.

40. A proton conducting membrane comprised of a functionalized fullerene and said NAFION, wherein the membrane is fabricated by the method in claim 14.

41. A proton conducting membrane comprised of a functionalized fullerene and a said polymer, wherein the membrane is fabricated by the method in claim 29.

42. A proton conducting membrane comprised of a functionalized fullerene and said perfluoro polymer sulfonic acid, wherein the membrane is fabricated by the method in claim 30.

43. A proton conducting membrane comprised of a functionalized fullerene and said NAFION, wherein the membrane is fabricated by the method in claim 31.

44. A proton conducting membrane comprised of a functionalized fullerene and said polymer, wherein the membrane is fabricated by the method in claim 32.

45. A proton conducting membrane comprised of a functionalized fullerene and said perfluoro polymer sulfonic acid, wherein the membrane is fabricated by the method in claim 33.

46. A proton conducting membrane comprised of a functionalized fullerene and said NAFION, wherein the membrane is fabricated by the method in claim 34.

47. A proton conducting membrane comprised of a cyano fullerene, C₆₀H(CN)ₙ, with n=1 to 5, and said polymer, wherein the membrane is fabricated by the method in claim 1.

48. A proton conducting membrane comprised of a cyano fullerene, C₆₀H(CN)ₙ, with n=1 to 5, and said perfluoro polymer sulfonic acid, wherein the membrane is fabricated by the method in claim 9.

49. A proton conducting membrane comprised of a cyano fullerene, C₆₀H(CN)ₙ, with n=1 to 5, and said NAFION, wherein the membrane is fabricated by the method in claim 11.

50. A proton conducting membrane comprised of a cyano fullerene, C₆₀H(CN)ₙ, with n=1 to 5, and said polymer, wherein the membrane is fabricated by the method in claim 12.

51. A proton conducting membrane comprised of a cyano fullerene, C₆₀H(CN)ₙ, with n=1 to 5, and said perfluoro polymer sulfonic acid, wherein the membrane is fabricated by the method in claim 13.

52. A proton conducting membrane comprised of a cyano fullerene, C₆₀H(CN)ₙ, with n=1 to 5, and said NAFION, wherein the membrane is fabricated by the method in claim 14.

53. A proton conducting membrane comprised of a cyano fullerene, C₆₀H(CN)ₙ, with n=1 to 5, and said polymer, wherein the membrane is fabricated by the method in claim 29.

54. A proton conducting membrane comprised of a cyano fullerene, C₆₀H(CN)ₙ, with n=1 to 5, and said perfluoro polymer sulfonic acid, wherein the membrane is fabricated by the method in claim 30.

55. A proton conducting membrane comprised of a cyano fullerene, C₆₀H(CN)ₙ, with n=1 to 5, and said NAFION, wherein the membrane is fabricated by the method in claim 31.

56. A proton conducting membrane comprised of a cyano fullerene, C₆₀H(CN)ₙ, with n=1 to 5, and said polymer, wherein the membrane is fabricated by the method in claim 32.

57. A proton conducting membrane comprised of a cyano fullerene, C₆₀H(CN)ₙ, with n=1 to 5, and said perfluoro polymer sulfonic acid, wherein the membrane is fabricated by the method in claim 33.

58. A proton conducting membrane comprised of a cyano fullerene, C₆₀H(CN)ₙ, with n=1 to 5) and said NAFION, wherein the membrane is fabricated by the method in claim 34.
